(19) United States
(12) Patent Application Publication
(10) Pub. No.: US 2026/0278647 A1
(43) Pub. Date: Sep. 17, 2026

(54) REAL-TIME BIDDING PROCESS FOR ADVERTISEMENT PAYLOAD

(71) Applicant: CATALINA MARKETING CORPORATION, St. Petersburg, FL (US)

(72) Inventors: Zubin SINGH, Cupertino, CA (US); Kevin HUNTER, La Jolla, CA (US); Julie VALDEZ, St. Petersburg, FL (US); James COOPER, St. Petersburg, FL (US); Kirk DIKUN, Tampa, FL (US); James ZINKOVITCH, Holiday, FL (US); Ray SALIMBANGON, Annapolis, MD (US); Dulani MCLAURIN, St. Petersburg, FL (US)

(21) Appl. No.: 19/667,568

(22) Filed: May 4, 2026

Related U.S. Application Data
(63) Continuation of application No. PCT/US2025/032661, filed on Jun. 6, 2025.
(60) Provisional application No. 63/657,361, filed on Jun. 7, 2024.

(51) Int. Cl. G06Q 30/0273; G06Q 20/20

(52) U.S. Cl. CPC G06Q 30/0275; G06Q 20/209

(57) ABSTRACT

A disclosure comprises systems and methods for generating an advertisement payload on a receipt at Point of Sale. The method comprises identifying a transaction at a point of sale (POS) wherein an advertisement payload can be provided to a customer; generating a bid request for an advertisement payload to be integrated in a receipt generated at the POS; transmitting the bid request to a plurality of demand site platforms (DSPs), wherein each DSP is associated with a retailer; receiving at least one bid response from the DSP associated with the retailer; determining a winning bid response from the at least one bid response; in response to determining the winning bid response, procuring an advertisement payload associated with the retailer; and generating the receipt at the point of sale (POS) comprising the advertisement payload.

### CROSS-REFERENCE TO RELATED APPLICATIONS

The present disclosure is a continuation of International Patent Application No. PCT/US2025/032661, entitled “REAL-TIME BIDDING PROCESS FOR ADVERTISEMENT PAYLOAD” to Singh, et al. filed Jun. 6, 2025, which is related to and claims priority under the PCT to US Prov. Appln. No. 63/657361, entitled “REAL-TIME BIDDING PROCESS FOR ADVERTISEMENT PAYLOAD” to Singh, et-al. filed on Jun. 7, 2024, the contents of each of which are hereby incorporated by reference in their entireties, for all purposes.

### TECHNICAL FIELD

The present disclosure generally relates to bidding advertisements at a POS transaction learning, and more particularly to determining advertisement content on receipt.

### BACKGROUND

Inducing shopping and exchanges by consumers can be enhanced by advertisements. An advertisement can comprise a standard brand awareness message, or incentive, or promotion. These advertisements can comprise a general offering wherein the specific demographics of a consumer are not considered. However, the return on investment for providing these advertisement to consumers may be enhanced by a more targeted effort to increase responsiveness by the consumer. Methods to generate these targeted advertisement campaigns can include targeting more specific consumer demographics and providing the advertisements across various channels, not limited to social, connected TV, mobile app and web, etc. Other examples can include advertisement campaigns targeted towards the consumer during a standard transaction printed at a point of sale terminal.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture suitable for presenting real-time bidding or an advertisement payload, according to some embodiments.

FIG. 2 is a block diagram illustrating an example server and client from the architecture of FIG. 1, according to certain aspects of the disclosure.

FIG. 3 is a block diagram depicting workflow for generating an advertising payload at a POS incorporating a real-time bidding system.

FIG. 4 illustrates a sequence diagram consistent with FIG. 1 for generating an advertising payload at a POS incorporating a real-time bidding system.

FIG. 5 illustrates a block diagram workflow for generating an advertising payload at a POS including an additional computing device to interface with the real-time bidding system.

FIG. 6 illustrates a sequence diagram consistent with FIG. 5 for generating an advertising payload at a POS including an additional computing device to interface with the real-time bidding system and overall print workflow.

FIG. 7A depicts an example receipt comprising an advertisement payload.

FIG. 7B depicts an example receipt comprising a plurality of advertisement payloads from different retailers.

FIG. 8 depicts a flowchart illustrating steps in a method for presenting real-time bidding or an advertisement payload.

FIG. 9 is a block diagram illustrating an example computer system with which the client and server of FIGS. 1 and 2 can be implemented.

In the figures, elements and steps denoted by the same or similar reference numerals are associated with the same or similar elements and steps, unless indicated otherwise.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### SUMMARY

In a first embodiment, a computer-implemented method includes identifying a transaction at a point of sale (POS) wherein an advertisement payload can be provided to a customer. The method includes generating a bid request for an advertisement payload to be integrated in a receipt generated at the POS. The method include transmitting the bid request to a plurality of demand site platforms (DSP), wherein each DSP is associated with a retailer. The method includes receiving at least one bid response from the DSP associated with the retailer. The method includes determining a winning bid response from the at least one bid response. The method includes procuring an advertisement payload associated with the retailer determining the winning bid response in response to determining the winning bid response. The method also includes generating the receipt at the point of sale (POS) comprising the advertisement payload.

In a second embodiment, a system includes one or more processors and memory storing instructions which, when executed by the processors, cause the system to perform operations including: to identify a transaction at a point of sale (POS) wherein an advertisement payload can be provided to a customer; to generate a bid request for an advertisement payload to be integrated in a receipt generated at the POS; to transmit the bid request to a plurality of demand site platforms (DSPs), wherein each DSP is associated with a retailer; to receive at least one bid response from the DSP associated with the retailer; to determine a winning bid response from the at least one bid response; to, in response to determining the winning bid response, procure an advertisement payload associated with the retailer; and to generate the receipt at the point of sale (POS) comprising the advertisement payload.

In a third embodiment, a non-transitory, computer-readable medium includes instructions which, when executed by a processor, cause a computer to execute a method, the method comprising: identifying a transaction at a point of sale (POS) wherein an advertisement payload can be provided to a customer. The method includes generating a bid request for an advertisement payload to be integrated in a receipt generated at the POS. The method includes transmitting the bid request to a plurality of demand site platforms (DSP), wherein each DSP is associated with a retailer. The method includes receiving at least one bid response from the DSP associated with the retailer. The method includes determining a winning bid response from the at least one bid response. The method includes procuring an advertisement payload associated with the retailer determining the winning bid response in response to determining the winning bid response. The method also includes generating the receipt at the point of sale (POS) comprising the advertisement payload.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The disclosure comprises of a system that can execute a real-time bidding transaction between programmatic enabled demand side platforms (DSPs), and be able to print an advertisement to a customer while checking out at the point-of-sale terminal. The originating bid request comprises of a series of data attributes not limited to context parameters like: time, day, location, retailer store identifier, user identifier, POS terminal identifier, etc. The attributes can be transmitted to the real-time bidding ecosystem to allow various retailers via their connection to the real-time bidding system to have access to DSPs, where the retailer can decide and place a bid-response. The bid-response can comprise an advertisement payload customized to the customer identified at the POS transaction. The disclosure can be used in both hardware setups 1) where there is a distinct third party, such as CATALINA®, computing device and distinct third party (e.g., CATALINA®) printer in conjunction with a store POS system and 2) where there is only a store POS system that can be in communication with a third party, such as CATALINA®, cloud platform via the store POS provider/manufacturer . The disclosure addresses the technical problem of managing, in real time, bidding data generated by the plurality of DSPs and ranking the bidding data associated with respective DSPs. Further, managing the bidding, in real time, addresses the temporal constraint of limited transaction periods, and configuring the bidding data in a displayable format on a hardcopy receipt with physical dimension constraints.

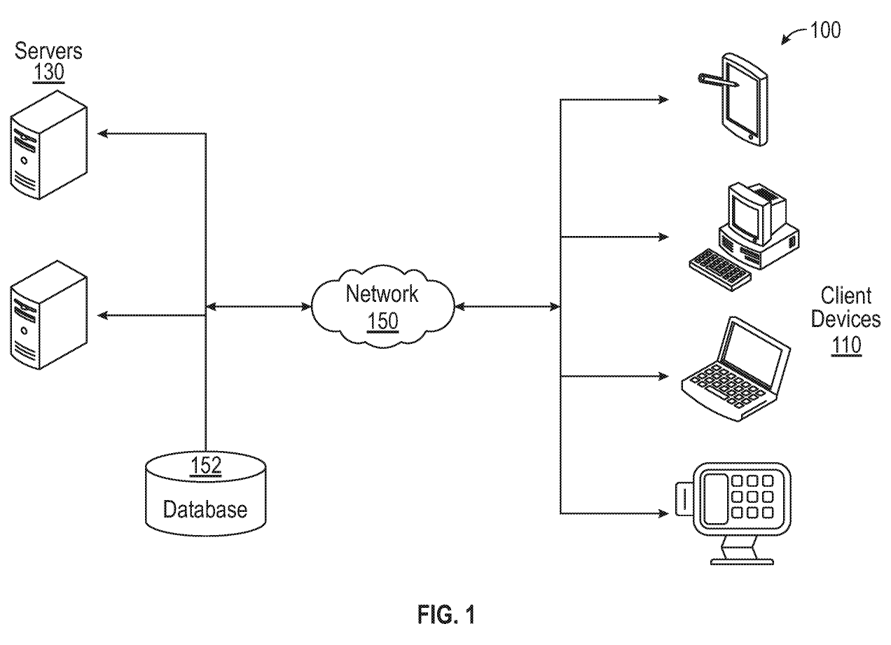

FIG. 1 illustrates an example architecture 100 for a multi-touch attribution engine suitable for practicing some implementations of the disclosure. Architecture 100 includes servers 130 and client devices 110 coupled over a network 150. One of the many servers 130 is configured to host a memory, including instructions which, when executed by a processor, cause the server 130 to perform at least some of the steps in methods as disclosed herein. In some embodiments, architecture 100 is configured to provide an advertisement payload to a consumer, who may be the user of client device 110. The advertisement payload may include a targeted digital promotion collected from a purchase history of the consumer, which may be stored in a history log in a memory of the server or in a database 152.

Servers 130 may include any device having an appropriate processor, memory, and communications capability for hosting the history log, a digital promotion database, an advertising technology server, a dynamic optimization engine, and a multi-touch attribution engine. The multi-touch attribution engine may be accessible by one or more client devices 110 over the network 150. In some embodiments, servers 130 may include a dynamic creative rendering server, a publisher, or supply side platform (SSP) server, and a demand side platform (DSP) server. Client devices 110 may include, for example, Point of Sale (POS) terminals, desktop computers, mobile computers, tablet computers (e.g., including e-book readers), mobile devices (e.g., a smartphone or PDA), or any other devices having appropriate processor, memory, and communications capabilities for accessing multi-touch attribution engines and the history log on one or more of servers 130. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

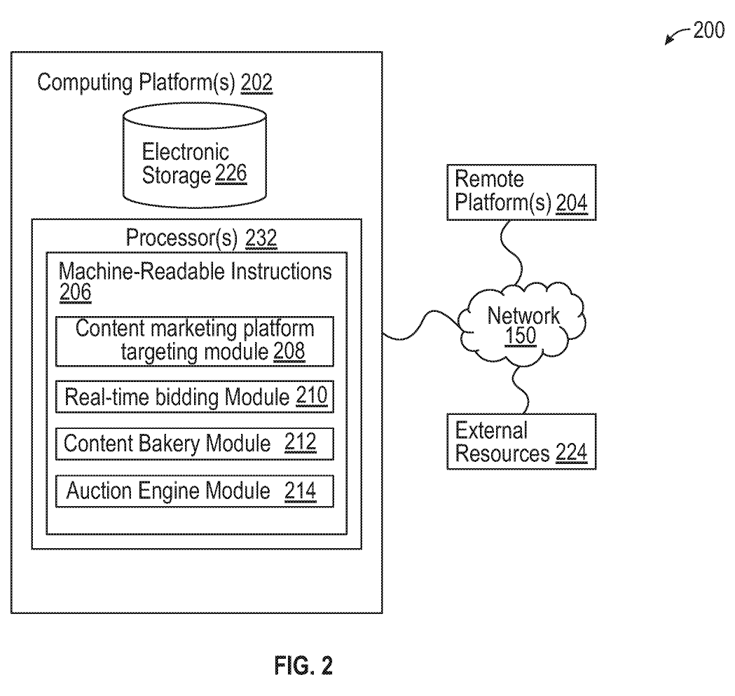

FIG. 2 is a block diagram illustrating an example computer system 200 (e.g., representing both client and server) with which aspects of the subject technology can be implemented. The computing platform(s) 202 may be configured to communicate with one or more remote platforms 204 according to a client/server architecture, a peer-to-peer architecture, and/or other architectures. The remote platform(s) 204 may be configured to communicate with other remote platforms via computing platform(s) 202 and/or according to a client/server architecture, a peer-to-peer architecture, and/or other architectures. In this way, the remote platform(s) 204 can be configured to cause sending bidding requests, receiving bidding responses, sending and receiving advertisement payloads, or general communication environments on client device(s) of the remote platform(s) 204, such as via a plurality of DSPs or POS terminals. The computing platform(s) 202, external resources 224, and remote platform(s) 204 may be in communication and/or mutually accessible via the network 150.

The computing platform(s) 202 may be configured by machine-readable instructions 206. The machine-readable instructions 206 may be executed by the computing platform(s) to implement one or more instruction modules. The instruction modules may include computer program modules. The instruction modules being implemented may include one or more of a content marketing platform targeting module 208, real-time bidding transformer module 210, content bakery module 212, auction engine module 214 and/or other instruction modules.

As discussed herein, instruction modules being implemented may include one or more of a content marketing platform targeting module 208 which can facilitate whether an opportunity to add an advertisement payload to a receipt is viable. The viability of integrating an advertisement payload can be based on transaction rules associated with a store location. For example, the type of product acquired or price point associated with the transaction can define a context which is correlated to a set of transaction rules. Further, the transaction rules can identify a set of retailers that may desire to integrate advertisement payloads to the customer’s receipt. If an opportunity exists based on the advertising rules, the real-time bidding (RTB) application program interface (API) can be called with the context and/or the store location.

The real-time bidding transformer module 210 can receive the context parameters associated with the transaction and generate a bid request object. The RTB transformer module 210 can proceed to communicate with the auction engine module 214. The auction engine module 214 can be configured to transmit a bid request object to the plurality of DSPs associated with retailers that were previously identified as potentially targets for advertisements payloads after evaluating context rules. The auction engine module 214 can also be configured to receive the various bid responses via the DSPs associated with respective retailers. The auction engine module 214 can also be configured to determine the winning bid response. In one aspect, the auction algorithm can use a ranking algorithm associated with the auction parameters. The ranking algorithm can comprise a heuristic model and/or machine learning model. In a further aspect, the machine learning model can comprise a neural network that implements nodes with auction parameters. The auction parameters can include a combination of the auction type, deal types, number of bidders, reserve prices, bid signals from various deals, and any bid adjustments applied by the exchange or supply side platform (SSP). In yet a further aspect, weights can be attached to the parameters such that the model can be further tuned in determining a winning bid response for the advertisement payload to integrate to the receipt.

The content bakery module 212 can be configured to generate an advertisement payload based on the requirements received from the winning bid response. The content bakery can either acquire the advertisement payload to be integrated on the receipt from the retailer using data received from the bid response, or in another aspect, the content bakery can use the payload parameters to generate the advertisement payload parameters to be formatted by the RTB transformer module 210.

In some implementations, the computing platform(s) 202, the remote platform(s) 204, and/or the external resources 224 may be operatively linked via one or more electronic communication links. For example, such electronic communication links may be established, at least in part, via the network 150 such as the Internet and/or other networks. It will be appreciated that this is not intended to be limiting, and that the scope of this disclosure includes implementations in which the computing platform(s) 202, the remote platform(s) 204, and/or the external resources 224 may be operatively linked via some other communication media. In a further aspect, the external resources 224 can comprise: a third party cloud platform, third party POS, third party printer, or third party database providing historical and/or sales data.

A given remote platform 204 may include client computing devices, such as a mobile device, tablet, personal computer, laptop, desktop, or POS terminal, which may each include one or more processors configured to execute computer program modules. The computer program modules may be configured to enable an expert or user associated with the given remote platform 204 to interface with the system 200 and/or external resources 224, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms. The external resources 224 may include sources of information outside of the system 200, external entities participating with the system 200, and/or other resources.

The computing platform(s) 202 may include the electronic storage 226, a processor such as the processors 232, and/or other components. The computing platform(s) 202 may include communication lines, or ports to enable the exchange of information with a network and/or other computing platforms. Illustration of the computing platform(s) 202 in FIG. 2 is not intended to be limiting. The computing platform(s) 202 may include a plurality of hardware, software, and/or firmware components operating together to provide the functionality attributed herein to the computing platform(s) 202. For example, the computing platform(s) 202 may be implemented by a cloud of computing platforms operating together as the computing platform(s) 202.

The electronic storage 226 may comprise non-transitory storage media that electronically stores information. The electronic storage media of the electronic storage 226 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). The electronic storage 226 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 226 may include one or more virtual storage resources (e.g., cloud storage, a virtual private network, and/or other virtual storage resources). The electronic storage 226 may store software algorithms, information determined by the processor(s) 232, information received from computing platform(s) 202, information received from the remote platform(s) 204, and/or other information that enables the computing platform(s) 202 to function as described herein.

The processor(s) 232 may be configured to provide information processing capabilities in the computing platform(s) 202. As such, the processor(s) 232 may include one or more of a digital processor, an analog processor, a digital circuit designed to process information, an analog circuit designed to process information, a state machine, and/or other mechanisms for electronically processing information. Although the processor(s) 232 is shown in FIG. 1 as a single entity, this is for illustrative purposes only. In some implementations, the processor(s) 232 may include a plurality of processing units. These processing units may be physically located within the same device, or the processor(s) 232 may represent processing functionality of a plurality of devices operating in coordination. The processor(s) 232 may be configured to execute modules 208, 210, 212, 214, and/or other modules. The processor(s) 232 may be configured to execute modules 208, 210, 212, 214, and/or other modules by software; hardware; firmware; some combination of software, hardware, and/or firmware; and/or other mechanisms for configuring processing capabilities on the processor(s) 232. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although the modules 208, 210, 212, and/or 214 are illustrated in FIG. 2 as being implemented within a single processing unit, in implementations in which the processor(s) 232 includes multiple processing units, one or more of the modules 208, 210, 212, and/or 214 may be implemented remotely from the other modules. The description of the functionality provided by the different modules 208, 210, 212, and/or 214 described herein is for illustrative purposes, and is not intended to be limiting, as any of the modules 208, 210, 212, and/or 214 may provide more or less functionality than is described. For example, one or more of the modules 208, 210, 212, and/or 214 may be eliminated, and some or all of its functionality may be provided by other ones of the modules 208, 210, 212, and/or 214. As another example, the processor(s) 232 may be configured to execute one or more additional modules that may perform some or all of the functionality attributed below to one of the modules 208, 210, 212, and/or 214.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

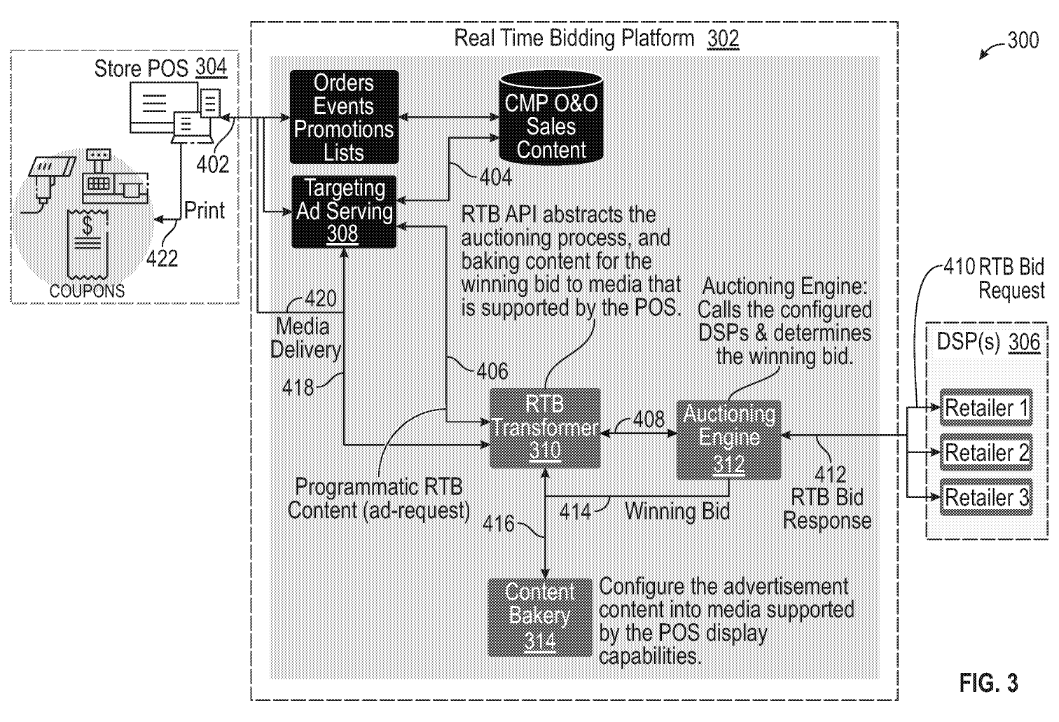

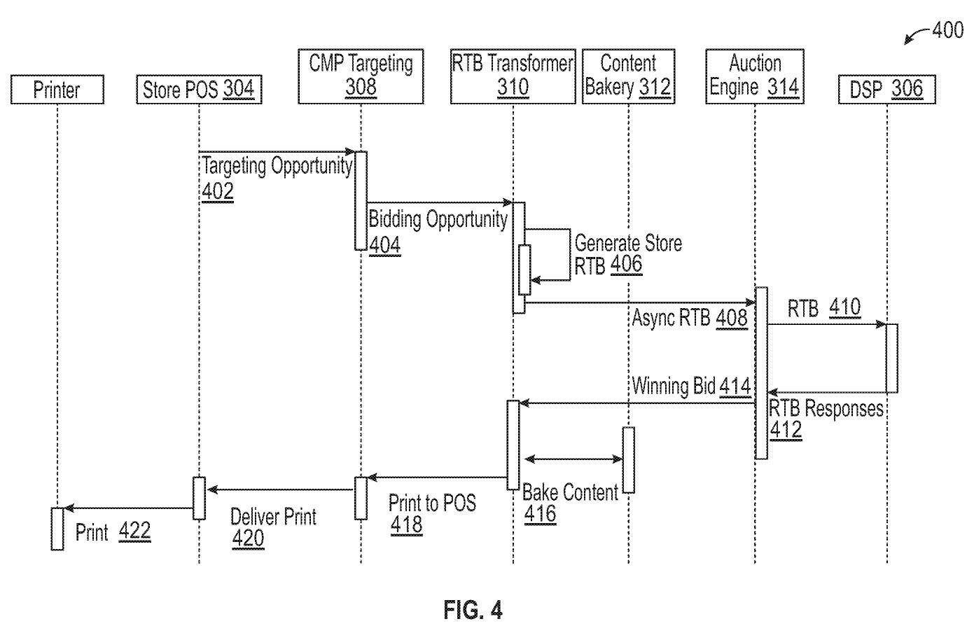

As depicted in FIG. 3, the system 300 can execute real-time bidding of potential advertisement payloads to be integrated into a receipt at a POS 304. The real-time bidding platform 302 is configured to manage bidding requests from retailers associated with the DSPs 306. FIG. 3 depicts the general workflow between the store POS 304, the bidding process platform 302 and the demand side platform DSP 306, who serve as a conduit to the various companies that may want to provide the resultant advertisement to the consumer at the POS. FIG. 4 depicts a discrete workflow 400 between the components of the POS 304, the components of bidding process platform 302, and DSP 306. At step 402, the initiation of a transaction identifies a potential targeting opportunity to provide an advertising payload to a customer at the conclusion of the transaction at a retail store. The POS terminal 304 can transmit the transaction message to the content marketing platform (CMP) targeting module 308. At step 404, a determination can be made whether there is an opportunity to initiate a bid based on the transaction rules associated with a store location. In another aspect, a context-aware targeting call can be performed in the CMP targeting module 308. If an opportunity exists based on the advertising rules, the real-time bidding (RTB) application program interface (API) can be called with the context or the store location.

At step 406, the RTB transformer module 310 can take the identified context and advertising rules and transform the context to an RTB enabled payload. At step 408, the RTB transformer module 310 calls the auction engine 314 with the RTB request object. At step 410, the RTB transformer multicasts bid-requests to the integrated DSPs 306 that the retailer is configured to provide an advertisement payload. Further at step 412, the DSPs 306 provide a plurality of bidding responses. The bid response object contains details on the ID of the bid, the type of deal, bid clearing price, ad identifier, campaign identifier, creative identifier, and the win notification URL that also then contains the advertisement payload and other attributes part of the bid-response stream. At step 412, the RTB bid responses are aggregated and analyzed. At step 414, the auction engine 314 provides the RTB transformer module 310 with the winning bid response object. A winning bid in a programmatic auction can be determined by auction parameters. The auction parameters can include a combination of the auction type, deal types, number of bidders, reserve prices, bid signals from various deals, and any bid adjustments applied by the exchange or supply side platform (SSP).

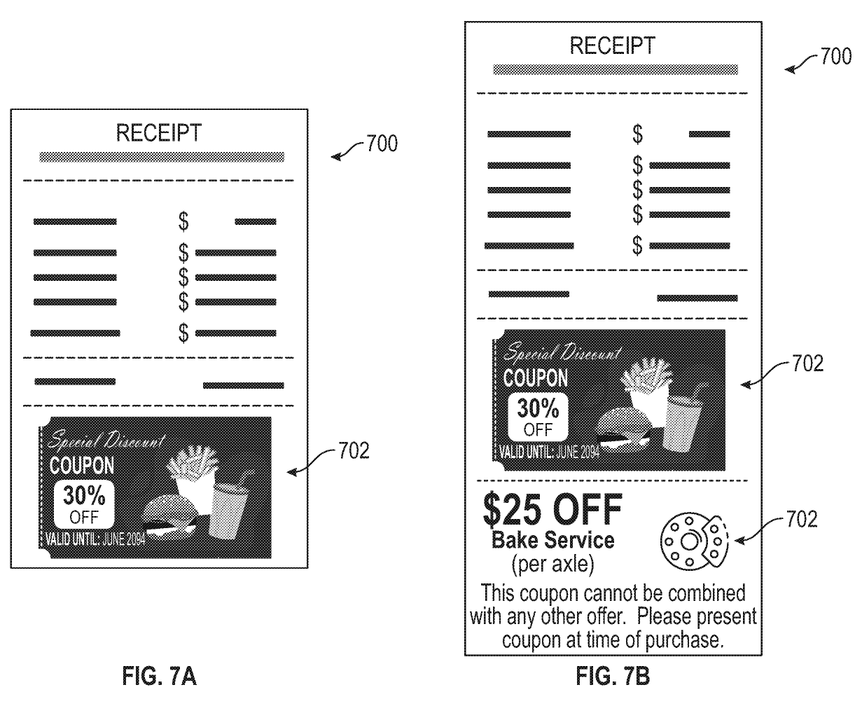

In other aspects, there can be a plurality of winning bid responses. The plurality of winning bid responses can be the result of multiple ranking schemes used for the combination of auction parameters. For example, the auction engine 314 can evaluate ranking schemes that place different weights of the auction parameters. The result of the varied weighting schemes for the auction parameters may yield different winning bids. In yet a further aspect, historical data such as sales data, from third parties such as CATALINA®, can influence the DSP and can identify a winning bid. At step 416, the media content for the winning bid can be converted to the appropriate media for integration by the printer at the store POS. In a further aspect, the structure and format of the media payload can be completed by the content bakery 312. At step 418, the targeting module can be called to print the media at the store POS printer. At step 420, the CMP targeting module 308 is called to print the identified advertisement payload at the store POS. At step 422, the store POS 304 prints the advertisement payload on the receipt 700. As depicted in FIG. 7A, the receipt 700 printed at a POS 304 can comprise a single winning bid wherein a single advertisement payload 702 is formatted and integrated to the receipt. In yet another aspect, the dimensions of the receipt 700 can permit multiple advertisement payloads to be provided to the receipt. FIG. 7B depicts a receipt with multiple winning bids.

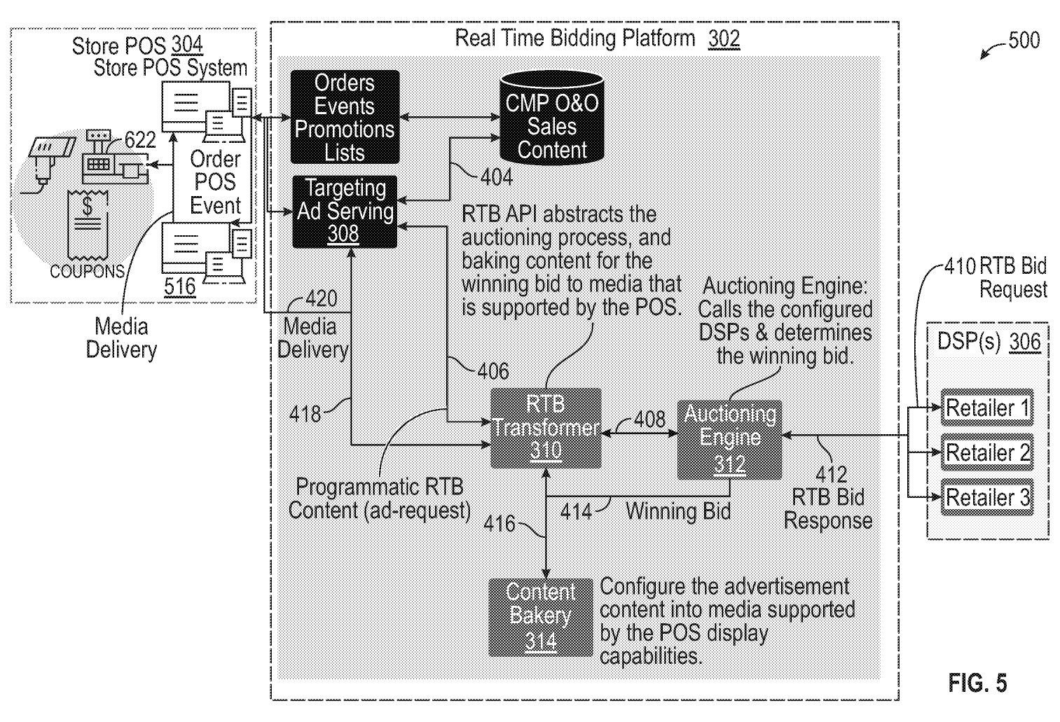

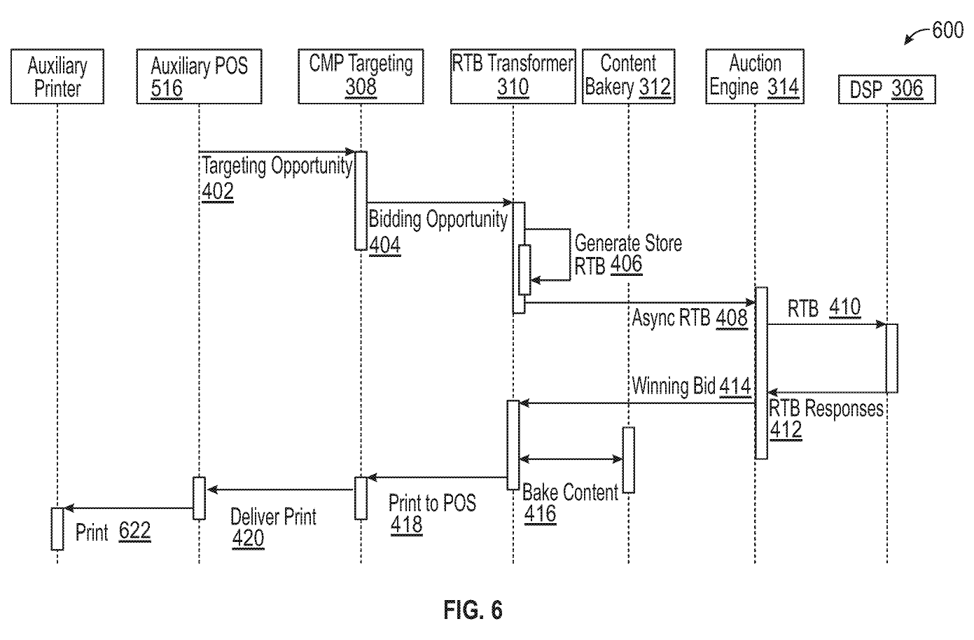

In an alternate embodiment, as depicted in FIGS. 5 and 6, a physical configuration for executing a transaction may have a primary POS 304 and a separate auxiliary (third party) POS 516 with an accompanying auxiliary (third party) printer 516. In a further aspect, the auxiliary POS 516 may be proprietary to the third party and configured to communicate with a primary POS 304. The system 500 may comprise both a primary POS 304 and auxiliary POS 516 to allow each POS to communicate and process more efficiently. For example, the system 500 can be configured to use differentiated tasks between the POS 516 to reduce computing load on each device. For example, in the workflow 600, as depicted in FIG. 6, the auxiliary POS 516 may be configured to perform the printing tasks 622 and communicate with CMP targeting module 308, while the primary POS 304 can be configured to communicate with a banking server to verify the transaction.

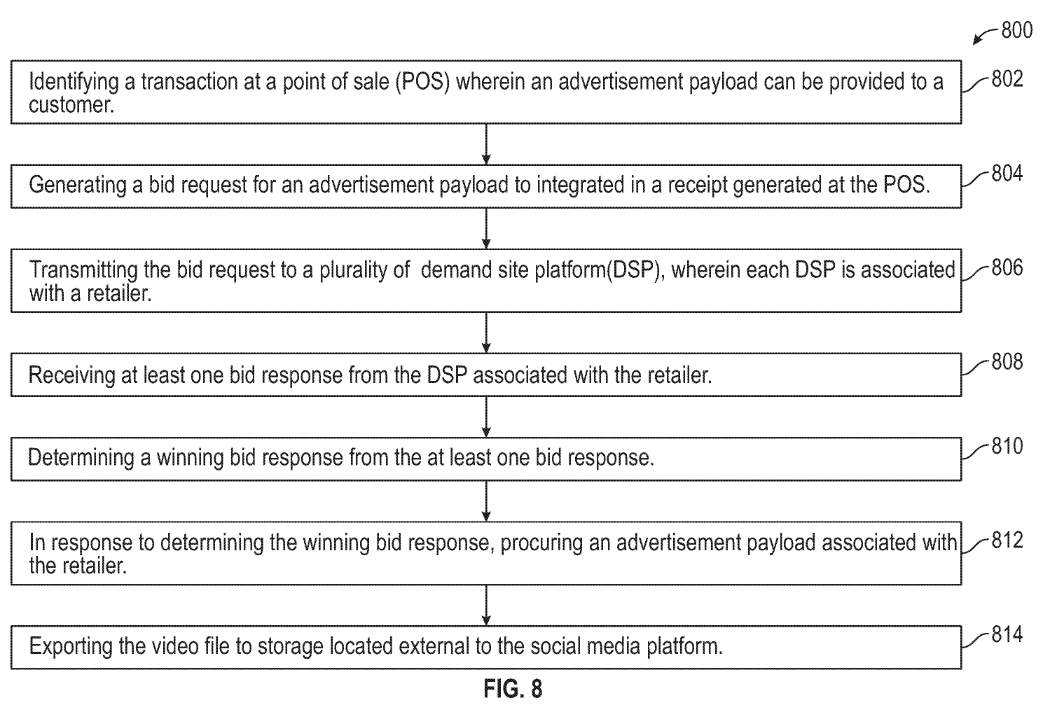

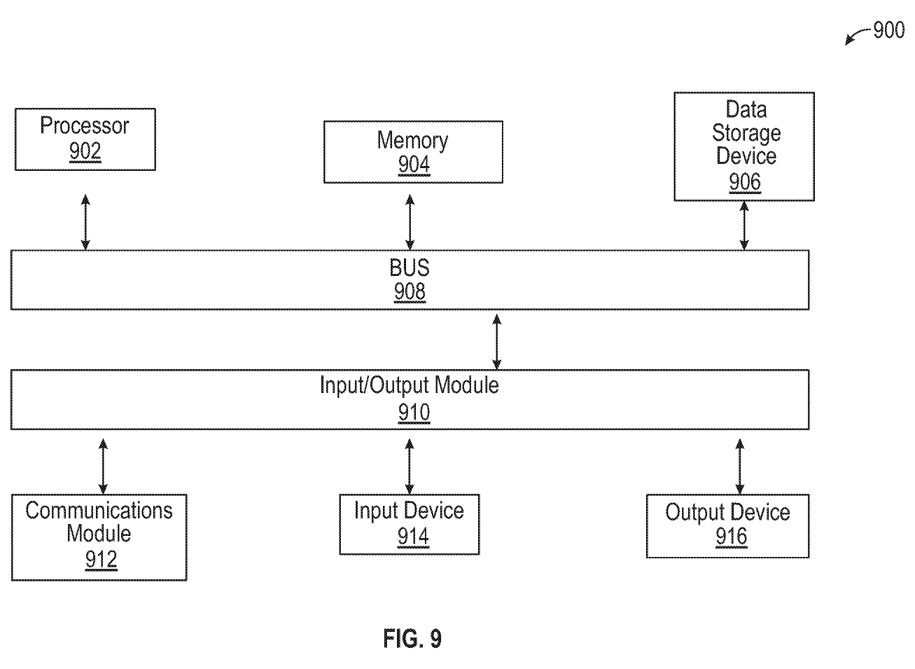

FIG. 8 is a flowchart illustrating steps in a method 800 for generating an advertisement payload as a result of a real-time bidding process. Method 800 may be performed at least partially by any one of the plurality of servers and client devices, such as a POS, as disclosed herein (e.g.,servers 130 and client devices 110). For example, at least some of the steps in method 800 may be performed by one component in a system, including a POS running code for an application hosted by a server. Accordingly, at least some of the steps in method 800 may be performed by a processor executing commands stored in a memory of the server, the mobile device, or a database accessible by the server or the POS device. Further, in some embodiments, at least some of the steps in method 800 may be performed overlapping in time, almost simultaneously, or in a different order from the order illustrated in method 800. Moreover, a method consistent with some embodiments disclosed herein may include at least one, but not all, of the steps in method 800.

Step 802 includes identifying a transaction at a point of sale (POS) wherein an advertisement payload can be provided to a customer.

Step 804 includes generating a bid request for an advertisement payload to be integrated in a receipt generated at the POS. In some embodiments, step 804 includes generating the bid request based on transaction rules associated with a store comprising the POS. In some embodiments, step 804 comprises context parameters including: time, day, location, retailer store identifier, user identification, and a POS terminal identifier.

Step 806 includes transmitting the bid request to a plurality of demand site platforms (DSPs), wherein each DSP is associated with a retailer.

Step 808 includes receiving at least one bid response from the DSP associated with the retailer.

Step 810 includes determining a winning bid response from the at least one bid response. In some embodiments, step 810 includes implementing a context aware targeting call. In some embodiments, step 810 includes determining at least one winning bid response comprises ranking an aggregated composition of auction parameters and bid adjustments.

Step 812 includes, in response to determining the winning bid response, procuring an advertisement payload associated with the retailer. In some embodiments, step 812 includes generating the advertisement payload includes integrating displayable media on a receipt from the POS. In some embodiments, step 812 comprises acquiring the advertisement payload includes receiving payload characteristics from the retailer via a URL integrated into the at least one bid response, wherein the payload characteristics are configured to be printed on a receipt from the POS.

Step 814 includes generating the receipt at the point of sale (POS) comprising the advertisement payload. In some embodiments, step 814 includes integrating a plurality of advertisement payloads wherein each of the payloads are configured to occupy a defined portion of the receipt consistent with the physical parameters of the receipt.

Computer system 900, the store POS and/or the CATALINA PC can include, in addition to hardware, code that creates an execution environment for the computer program in question, e.g., code that constitutes processor firmware, a protocol stack, a database management system, an operating system, or a combination of one or more of them stored in an included memory 904, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, i.e., one or more modules of computer program instructions encoded on a computer-readable medium for execution by, or to control the operation of, the computer system 900, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled to bus 908 for storing information and instructions. Computer system 900 may be coupled via input/output module 910 to various devices. The input/output module 910 can be any input/output module. Exemplary input/output modules 910 include data ports such as USB ports. The input/output module 910 is configured to connect to a communications module 912. Exemplary communications modules 912 include networking interface cards, such as Ethernet cards and modems. In certain aspects, the input/output module 910 is configured to connect to a plurality of devices, such as an input device 914 and/or an output device 916. Exemplary input devices 914 include a keyboard and a pointing device, e.g., a mouse or a trackball, by which a user can provide input to the computer system 900. Other kinds of input devices 914 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 916 include display devices such as an LCD (liquid crystal display) monitor, for displaying information to the user. In another aspect, the exemplary output device 916 can comprise mixed reality glasses. The glasses can be coupled via Bluetooth connection.

According to one aspect of the present disclosure, the above-described gaming systems can be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in the main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires forming bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g.,each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g.,his) include the feminine and neuter gender (e.g.,her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method comprising:
identifying a transaction at a point of sale (POS) wherein an advertisement payload can be provided to a customer;
generating a bid request for an advertisement payload to be integrated in a receipt generated at the POS;
transmitting the bid request to a plurality of demand site platforms (DSPs), wherein each DSP is associated with a retailer;
receiving at least one bid response from the DSP associated with the retailer;
determining a winning bid response from the at least one bid response;
in response to determining the winning bid response, procuring an advertisement payload associated with the retailer; and
generating the receipt at the point of sale (POS) comprising the advertisement payload.

2. The method of claim 1, wherein generating the bid request is based on transaction rules associated with a store comprising the POS.

3. The method of claim 2, wherein determining the bid request comprises implementing a context aware targeting call.

4. The method of claim 1, wherein the bid request comprises context parameters including: time, day, location, retailer store identifier, user identification, and a POS terminal identifier.

5. The method of claim 1, wherein procuring an advertisement payload comprises generating a payload such that generating the advertisement payload includes integrating displayable media on a receipt from the POS.

6. The method of claim 1, wherein procuring an advertisement payload comprises acquiring the advertisement payload and includes receiving payload characteristics from the retailer via a URL integrated into the at least one bid response, wherein the payload characteristics are configured to be printed on a receipt from the POS.

7. The method of claim 1, wherein determining at least one winning bid response comprises ranking an aggregated composition of auction parameters and bid adjustments.

8. The method of claim 1, wherein generating a receipt at a point of sale (POS) comprises integrating a plurality of advertisement payloads wherein each of the advertisement payloads are configured to occupy a defined portion of the receipt consistent with physical dimensions of the receipt.

9. A system, comprising:
one or more processors; and
a memory storing instructions which, when executed by the one or more processors, cause the system to perform operations comprising:
identifying a transaction at a point of sale (POS) wherein an advertisement payload can be provided to a customer;
generating a bid request for an advertisement payload to be integrated in a receipt generated at the POS;
transmitting the bid request to a plurality of demand site platforms (DSPs), wherein each DSP is associated with a retailer;
receiving at least one bid response from the DSP associated with the retailer;
determining a winning bid response from the at least one bid response;
in response to determining the winning bid response, procuring an advertisement payload associated with the retailer; and
generating the receipt at the point of sale (POS) comprising the advertisement payload.

10. The system of claim 9, further comprising an auxiliary computing device that includes an auxiliary printing device, wherein the auxiliary computing device is in electrical communication with a store POS.

11. The system of claim 9, wherein generating the bid request is based on transaction rules associated with a store comprising the POS.

12. The system of claim 10, wherein determining the bid request comprises implementing a context aware targeting call.

13. The system of claim 9, wherein the bid request comprises context parameters including: time, day, location, retailer store identifier, user identification, and a POS terminal identifier.

14. The system of claim 9, wherein procuring an advertisement payload comprises generating a payload such that generating the advertisement payload includes integrating displayable media on a receipt from the POS.

15. The system of claim 9, wherein procuring an advertisement payload comprises acquiring the advertisement payload and includes receiving payload characteristics from the retailer via a URL integrated into the at least one bid response, wherein the payload characteristics are configured to be printed on a receipt from the POS.

16. The system of claim 9, wherein determining at least one winning bid response comprises ranking an aggregated composition of auction parameters and bid adjustments.

17. The system of claim 9, wherein generating a receipt at a point of sale (POS) comprises integrating a plurality of advertisement payloads wherein each of the advertisement payloads are configured to occupy a defined portion of the receipt consistent with the physical dimensions of the receipt.

18. A non-transitory computer-readable medium, storing instructions which, when executed by a processor, cause a computer to execute a method, the method comprising:
identifying a transaction at a point of sale (POS) wherein an advertisement payload can be provided to a customer;
generating a bid request for an advertisement payload to be integrated in a receipt generated at the POS;
transmitting the bid request to a plurality of demand site platforms (DSPs), wherein each DSP is associated with a retailer;
receiving at least one bid response from the DSP associated with the retailer;
determining a winning bid response from the at least one bid response;
in response to determining the winning bid response, procuring an advertisement payload associated with the retailer; and
generating the receipt at the point of sale (POS) comprising the advertisement payload.

19. The non-transitory computer-readable medium of claim 18, wherein procuring an advertisement payload comprises generating a payload such that generating the advertisement payload includes integrating displayable media on a receipt from the POS.

20. The non-transitory computer-readable medium of claim 18, wherein procuring an advertisement payload comprises acquiring the advertisement payload and includes receiving payload characteristics from the retailer via a URL integrated into the at least one bid response, wherein the payload characteristics are configured to be printed on a receipt from the POS.
